(19) United States
(12) Patent Application Publication
(10) Pub. No.: US 2026/0194037 A1
(43) Pub. Date: Jul. 9, 2026

(54) Hydraulic Motor with an Enhanced Multi-Purpose Passage

(71) Applicant: Parker-Hannifin Corporation, Cleveland, OH (US)

(72) Inventors: Michael T. Crosby, Jonesborough, TN (US); Kyle J. Merrill, Chuckey, TN (US); Michael L. Masoner, Greeneville, TN (US); Brock A. Bowers, Greeneville, TN (US); Scott A. Emmette, Chuckey, TN (US); Jacob P. Sebera, Parma, OH (US)

(21) Appl. No.: 19/128,424

(22) PCT Filed: Dec. 11, 2023
(86) PCT No.: PCT/US2023/083280

§ 371 Date: May 8, 2025

Related U.S. Application Data
(60) Provisional application No. 63/479,762, filed on Jan. 13, 2023.

(51) Int. Cl. F03C 2/08

(52) U.S. Cl. CPC F03C 2/08; F01C 1/104; F04C 2/103; F04C 2240/805

(57) ABSTRACT

An example stator of a hydraulic motor includes a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter.

### CROSS REFERENCE TO RELATED APPLICATION

The present application claims priority to U.S. Provisional Patent Application No. 63/479,762, filed on Jan. 13, 2023, the entire contents of which are herein incorporated by reference as if fully set forth in this description.

### BACKGROUND

Hydraulic motors can be configured to receive fluid as an input and provide high torque rotational movement as an output. Such hydraulic motors can include gear sets configured to cooperatively define fluid chambers. The chambers expand when hydraulically connected to a source (e.g., a pump) of fluid and contract when connected to a drain that returns the fluid to the source or a fluid reservoir. The expansion and contraction of the fluid chambers causes the rotational movement.

A hydraulic motor may have many passages for fluid flow, fasteners, etc. The shape of such passages can affect performance of the motor and the overall cost of manufacturing the motor. It is with respect to these and other considerations that the disclosure made herein is presented.

### SUMMARY OF THE INVENTION

The present disclosure describes implementations that relate to a hydraulic motor with an enhanced Multi-purpose passage.

In a first example implementation, the present disclosure describes a stator of a hydraulic motor. The stator includes: a stator body having (i) a central opening configured to receive a rotor therein, and (ii) a plurality of vanes configured to interact with lobes of the rotor; and a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter.

In a second example implementation, the present disclosure describes a hydraulic motor including the stator of the first example implementation and a rotor disposed within the central opening of the stator body, wherein the rotor comprises a plurality of external lobes configured to engage with the plurality of vanes of the stator, such that the plurality of vanes and the plurality of external lobes define fluid chambers therebetween configured to expand and contract as the rotor rotates within the stator.

In a third example implementation, the present disclosure describes a hydraulic transmission including a pump configured to provide fluid the hydraulic motor of the second example implementation fluidly coupled to the pump and configured to receive fluid therefrom.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 illustrates a cross-sectional side view of a hydraulic motor, in accordance with an example implementation.

FIG. 2 illustrates an exploded perspective view of the hydraulic motor of FIG. 1, in accordance with an example implementation.

FIG. 3 illustrates another cross-sectional view of a hydraulic motor, in accordance with an example implementation.

FIG. 4 illustrates a schematic partial lateral view of a rotor set assembly with fluid flow passages projected thereon, in accordance with an example implementation.

FIG. 5 illustrates a cross-sectional view of a stator including passages having a substantially oval shape, in accordance with an example implementation.

FIG. 6 illustrates a cross-sectional view of a stator 146 including passages having a composite profile of two holes, in accordance with an example implementation.

FIG. 7 illustrates a partial, enlarged cross-sectional view of the stator shown in FIG. 6, in accordance with an example implementation.

FIG. 8 illustrates the partial, enlarged cross-sectional view of FIG. 7 with a bolt disposed in the passage of the stator, in accordance with an example implementation.

### DETAILED DESCRIPTION

An example low-speed High-Torque (LSHT) hydraulic motor (e.g., a geroller or gerotor hydraulic motor) can have a plurality of passages, each passage can have a fastener (e.g., bolt) disposed therethrough, and each passage is also used to allow fluid flow therethrough. Such passage may have a complex shape and may require several machining steps to form it. Such complex shape and machining may be costly and may provide implementation challenges. It may thus be desirable to have such passages configured with a shape that is less costly to manufacture while being effective in providing fluid flow and enabling the fasteners to perform their intended function (e.g., torque transfer and axial retention of various components of the motor).

Disclosed herein are systems, assemblies, hydraulic motors, and method associated with hydraulic motors with enhanced Multi-purpose passages. The passages are configured to receive respective bolts therethrough while allowing fluid flow through each passage around a respective bolt disposed in the passage. Each passage includes a composite of a first hole and a second hole, wherein the first hole has a first diameter and the second hole has a second diameter larger than the first diameter.

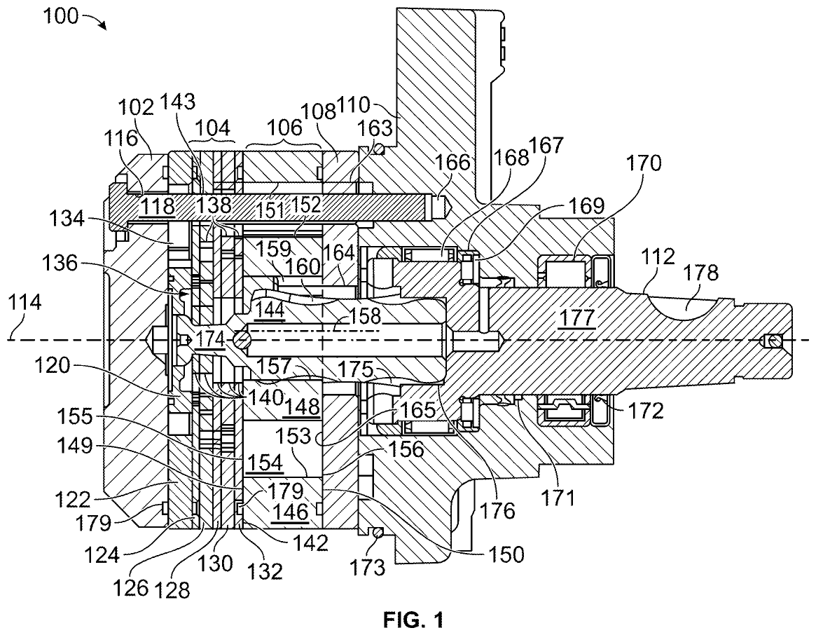

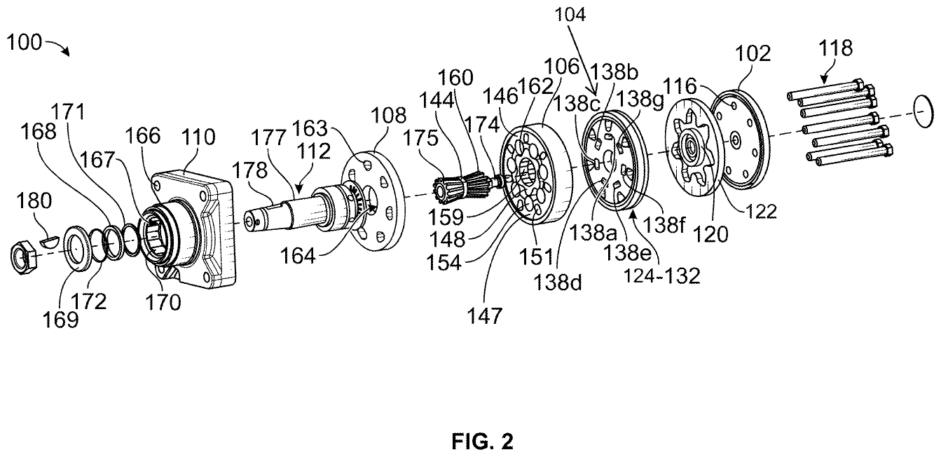

FIG. 1 illustrates a cross-sectional side view of a hydraulic motor 100, and FIG. 2 illustrates an exploded perspective view of the hydraulic motor 100, in accordance with an example implementation. FIGS. 1-2 are described together.

The hydraulic motor 100 includes an end plate 102, a manifold 104, a rotor set assembly 106, a wear plate 108, a housing 110, an drive assembly 112, and a longitudinal axis 114. The end plate 102, the manifold 104, the rotor set assembly 106, the wear plate 108, the housing 110, and the drive assembly 112 can each be generally cylindrical as shown in FIG. 2.

Although the components of the hydraulic motor 100 are depicted as being separate components, in other implementations, some of these components can be integral with one another. Further, the hydraulic motor 100 can be a separate structure from other hydraulic components in a hydraulic circuit in which it is used, or it can be integral with and in a common housing with other components in a hydraulic circuit, or it can be bolted to such other components. For example, the hydraulic motor 100 can be bolted to a hydraulic pump or can be integrated with a hydraulic pump with a common housing. Such motor and pump assembly can be referred to as a hydraulic transmission.

The hydraulic motor 100 is driven in a rotational direction around its longitudinal axis 114 by fluid from the hydraulic pump in a forward direction or in a reverse direction. In an example, the hydraulic motor 100 is configured such that its forward direction is counter-clockwise when viewed in a longitudinal direction from its right end from the perspective of FIG. 1 looking toward its left end. When the terms counter-clockwise and clockwise are used herein, it is with reference to viewing the hydraulic motor 100 in such longitudinal direction. The reverse direction of the hydraulic motor 100 is clockwise. The operation of the hydraulic motor 100 is described below in the forward direction, and the reverse rotational direction of the hydraulic motor 100 can be achieved by reversing the flow of hydraulic fluid through the hydraulic motor 100.

The end plate 102 of the hydraulic motor 100 includes a plurality of end plate bolt holes, such as hole 116, configured to receive bolts 118 (e.g., threaded bolts or any type of fasteners). The bolts 118 secure or clamp the end plate 102, the manifold 104, the rotor set assembly 106, the wear plate 108, and the housing 110 together.

The hydraulic motor 100 includes a commutator 120 that is rotatable and disposed within a commutator ring 122 that is stationary. The manifold 104 includes several manifold plates such as manifold plate 124, manifold plate 126, manifold plate 128, manifold plate 130, and manifold plate 132 configured to be stationary plates. The commutator 120 is configured to separate a chamber 134 from a chamber 136 shown in FIG. 1.

The hydraulic motor 100 can be bi-directional. Thus, in one operating condition, the chamber 134 can operate as an inlet chamber, while the chamber 136 can operate as an outlet chamber. In a second operating condition, the chamber 134 can operate as an outlet chamber, while the chamber 136 can operate as an inlet chamber.

The manifold plates 124-132 can each include a plurality of fluid passages 138 (including fluid passage 138a, fluid passage 138b, fluid passage 138c, fluid passage 138d, fluid passage 138e, fluid passage 138f, and fluid passage 138g) and fluid passages 140 (e.g., central holes) that extend through the manifold plates 124-132. The fluid passages 138 can be referred to as openings or windows and can be configured to terminate at an end face 142 of the manifold plate 132. The manifold plates 124-132 each also include respective seven bolt holes 143 for receiving the bolts 118 and for providing a fluid flow path.

The commutator 120 is configured to be driven by a drive link 144 that can be considered part of the drive assembly 112. The rotor set assembly 106, the drive assembly 112, and the drive link 144 can collectively be referred to as a drive assembly. The commutator 120 is moved by the drive link 144 in an orbital path relative to the manifold plates 124-132 to open and close fluid communication between the chamber 134 and the fluid passages 138 and also between the chamber 136 and the fluid passages 138.

The fluid passages 138 of the manifold 104 are configured to supply higher pressure hydraulic fluid to, and receive lower pressure return hydraulic fluid from, the rotor set assembly 106 to cause rotation of the output assembly as further described below. The end face 142 of the manifold plate 132 of the manifold 104 is disposed in a plane perpendicular to the longitudinal axis 114.

The rotor set assembly 106 includes a stator 146 and a rotor 148. The rotor 148 is configured to be rotatably disposed within an inner space or central opening of the stator 146. As shown in FIG. 1, the stator 146 and the rotor 148 each includes an end face 149 that engages or interfaces with the end face 142 of the manifold plate 132 of the manifold 104. The stator 146 and the rotor 148 each also include another end face 150 that is parallel to the end face 149 and engages or interfaces with the wear plate 108.

The stator 146 can include a stator body 147 having respective bolt holes or passages, such as passage 151 shown in FIG. 1, for receiving the bolts 118 therethrough. As described in more details below, fluid flows through the passages 151 around the bolts 118. Thus, the passage 151 is a multi-purpose passage that accommodates the bolt 118 and allows fluid flow therethrough.

Throughout this disclosure, the bolts can be referred to in the singular as the bolt 118 to refer to a particular bolt or in the plural as the bolts 118 to collectively refer to all the bolts that are disposed in a circular array about the hydraulic motor 100. Similarly, the passages in which the bolts 118 are disposed can be referred to in the singular as the passage 151 to refer to a particular passage or in the plural as the passages 151 to collectively refer to all the passages through which the bolts 118 are disposed.

The stator body 147 of the stator 146 also includes a central opening 152 that is longitudinally-extending along the longitudinal axis 114. The central opening 152 is generally circular in lateral cross section.

The central opening 152 of the stator 146 provides multiple (e.g., seven) roller cavities or roller pockets 153 configured as semi-circular longitudinally-extending pockets and disposed in a circular array about interior surface of the stator 146. Each of the roller pockets 153 is configured to receive a longitudinally-extending cylindrical roller, such as roller 154. Throughout this disclosure, the rollers can be referred to in the singular as the roller 154 to refer to a particular roller or in the plural as rollers 154 to collectively refer to the rollers of the stator 146. The rollers 154 can be configured to rotate freely in their respective roller pockets.

The rollers 154 can also be referred to as vanes or vane rollers and are configured to operate as internal gear members of the stator 146 formed within the central opening 152. The gear members operate as gear teeth that engage the lobes of the rotor 148. However, it should be understood that other types of vanes could be used other than rollers. Although the hydraulic motor 100 shown and described herein is a geroller hydraulic motor having roller-type vanes, the disclosure presented herein is applicable to other types of hydraulic motors that have other types of vanes (e.g., a gerotor motor with a stator and rotor only, where the vanes are built into the stator as inner teeth instead of using rollers as vanes). Thus, the rollers 154 can also be referred to as a plurality of vanes of the stator 146. The rollers 154 each include a cylindrical exterior surface between end face 155 and end face 156 as shown in FIG. 1.

Referring to FIGS. 1 and 2, the rotor 148 includes a longitudinally-extending central opening 157 and a longitudinal axis 158. The longitudinal axis 158 is parallel to, and radially-offset from, the longitudinal axis 114 of the stator 146. The surface of the longitudinally-extending central opening 157 of the rotor 148 is generally circular in lateral cross section and has a plurality of splines 159 for mating with corresponding external splines 160 located on the drive link 144.

The exterior surface of the rotor 148 defines a plurality of external lobes 162 (e.g., protrusions similar to gear teeth) shown in FIG. 2 configured to interact with the rollers 154 of the stator 146. The number of external lobes 162 of the rotor 148 can be one less than the number of rollers 154 of the stator 146. The external lobes 162 mesh with the rollers 154 as the rotor 148 rotates and orbits relative to the stator 146. In the counter-clockwise rotational direction of the hydraulic motor 100, the rotor 148 and the drive link 144 both rotate in the counter-clockwise direction, and the rotor 148 and the commutator 120 both orbit in the clockwise direction due to interaction between the external lobes 162 of the rotor 148 and the rollers 154.

The wear plate 108 includes bolt holes 163 for receiving the bolts 118. The wear plate 108 also includes a central opening 164 that is longitudinally-extending along the longitudinal axis 114. The wear plate 108 also includes an end face 165 that is parallel to, and engages or interfaces with, the end faces 150 of the stator 146 and the rotor 148.

The housing 110 includes blind threaded bolt holes 166 configured to receive the threaded ends of the bolts 118. The housing 110 also includes a central opening 167 arranged along the longitudinal axis 114.

The central opening 167 is stepped to receive suitable bearings such as bearing 168, bearing 169, and bearing 170 for supporting the drive assembly 112. The central opening 167 also carries suitable seals such as seal 171 and seal 172 for precluding egress or leakage of hydraulic fluid and ingress of dirt and other foreign materials into the central opening 167. An external groove on the exterior surface of the housing 110 is configured to receive a seal 173 that seals against a surface of a hydraulic pump to which the hydraulic motor 100 can be coupled.

The drive link 144 includes a commutator drive extension 174 configured to be received in a corresponding central opening in the commutator 120 to drive the commutator 120 in a clockwise orbital path relative to the manifold 104. The drive link 144 also includes splines 175 that mesh with splines 176 formed on an interior surface of an output shaft 177 of the drive assembly 112.

The drive link 144 is configured to be driven by engagement of the splines 159 of the rotor 148 with the splines 160 of the drive link 144. The central region of the drive link 144 is supported in the central opening 164 of the wear plate 108 to permit rotational and rocking movement of the drive link 144 relative to the wear plate 108.

The splines 160 and the splines 175 of the drive link 144 can transmit torque from the rotor 148 through the drive link 144 to the output shaft 177. In this manner, energy from the pressurized fluid that drives the rotor 148 is transmitted to the output shaft 177. A key slot 178 formed on the exterior surface of the output shaft 177 is configured to connect the output shaft 177 to the device that is to be driven by the hydraulic motor 100 (e.g., to a wheel of a lawn mower) via a key 180 shown in FIG. 2. However, in the example implementation shown in the Figures, the key slot 178 and the key 180 might not be the primary method of torque transfer. Rather, as illustrated, the output shaft 177 is tapered and can form a “taper lock” with device being driven by the output shaft 177 (e.g., a self-holding taper arrangement).

The end plate 102 includes a groove 179 and the manifold 104 also includes a similar groove 179 that are generally circular and configured to receive generally circular seals. Such seals can prevent leakage between the end plate 102 and the commutator ring 122, between the commutator ring 122, and the manifold 104 and the rotor set assembly 106.

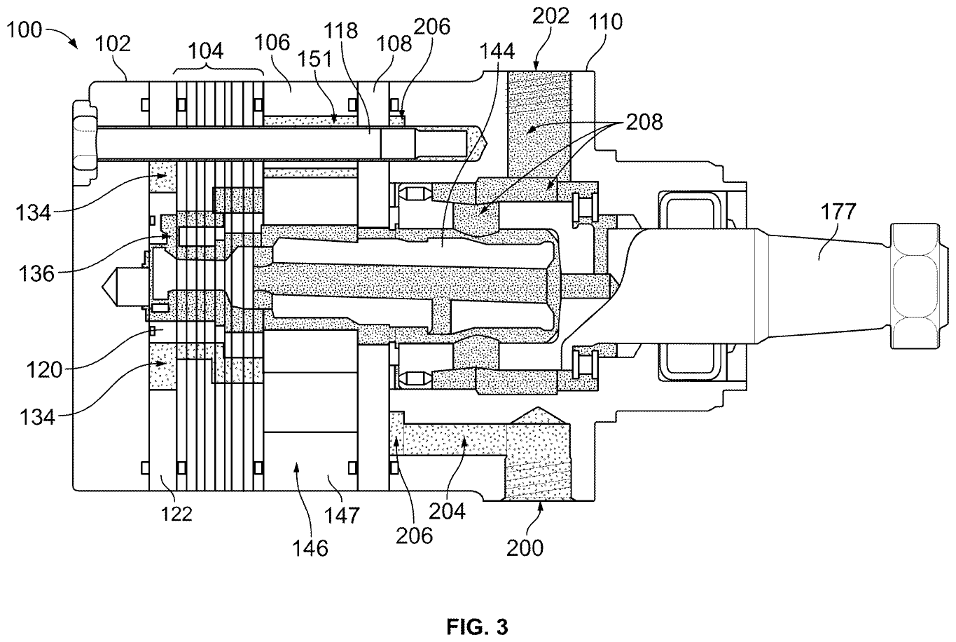

FIG. 3 illustrates another cross-sectional view of the hydraulic motor 100, in accordance with an example implementation. As shown, the hydraulic motor 100 can have a first port 200 and a second port 202 in the housing 110. In one operating condition, the first port 200 can be an inlet port that is fluidly coupled to a source of hydraulic fluid (e.g., a variable displacement hydraulic pump). In this operating condition, the output shaft 177 rotates in a first rotational direction (e.g., forward direction), and the second port 202 can be an outlet port through which fluid is discharged from the hydraulic motor 100. In FIG. 3, the first port 200 and the second port 202 are disposed in the housing 110. However, in other example implementations, the ports can be disposed in an end cover at the rear of the motor. Thus, the configuration of the ports is not meant to be limiting.

The hydraulic motor 100 is bi-directional as mentioned above, and thus in a second operating condition the second port 202 can be the inlet port that is fluidly coupled to the source of hydraulic fluid, while the first port 200 can be the outlet port. In this operating condition, the output shaft 177 rotates in a second rotational direction (e.g., reverse direction), opposite the first rotational direction.

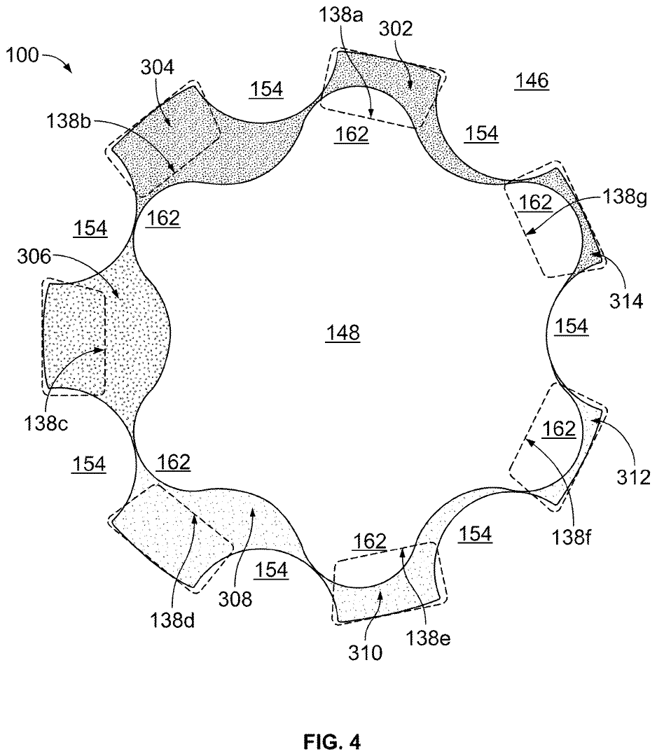

Assuming the hydraulic motor 100 is operating in the first operating direction, fluid is received at the first port 200, and is then communicated through a channel 204 to an annular chamber 206 (fluid is depicted in FIG. 3 with a dot pattern where different pressure levels have different patterns). Fluid is then communicated from the annular chamber 206 through the passages 151 (of the stator 146), which accommodate the bolts 118, around the bolts 118 to the chamber 134. From the chamber 134 fluid is communicated through a subset of the fluid passages 138a-138g in the manifold plates 124-132 to the rotor set assembly 106 causing the rotor 148 to rotate as described below with respect to FIG. 4.

Fluid discharged from the rotor set assembly 106 flows back to the chamber 136 through the manifold 104. Fluid is then communicated again through the manifold 104, around and through the drive link 144, then through fluid passages 208 to the second port 202.

FIG. 4 illustrates a schematic partial lateral view of the rotor set assembly 106 with the fluid passages 138a-138g superimposed or projected thereon, in accordance with an example implementation. Although not shown in the schematic view of FIG. 4, the rotor 148 includes the longitudinally-extending central opening 157 and has the splines 159 described above. Also, fluid is depicted in FIG. 4 with a dot pattern where different pressure levels have different patterns.

The stator 146 defines the roller pockets 153 on an interior surface of the stator 146, and the roller pockets 153 receive the rollers 154 therein. The rollers 154 of the stator 146 and the external lobes 162 of the rotor 148 effectively engage and cooperatively define respective fluid chambers such as fluid chamber 302, fluid chamber 304, fluid chamber 306, fluid chamber 308, fluid chamber 310, fluid chamber 312, and fluid chamber 314, in the rotor set assembly 106. The fluid chambers 302-314 are separated from one another by effective moving contact between the external lobes 162 and the rollers 154.

As the rotor 148 rotates and orbits within the stator 146, the fluid chambers 302-314 each expand and contract. The fluid chambers 302-314 can include a portion of, and are fluidly coupled to, the adjacent fluid passage of the fluid passages 138a-138g. This way, the fluid chambers 302-314 can have substantially the same pressure level of fluid as the pressure level of fluid in the corresponding or adjacent fluid flow passage of the fluid passages 138a-138g.

As an example to illustrate operation of the hydraulic motor 100, the rotary and orbital movement of the rotor 148 can be caused by hydraulic fluid that is provided from the first port 200 (see FIG. 3) through the passages 151 to the chamber 134, and directed by the commutator 120 from the chamber 134 to the fluid passages 138d, 138e, and 138f. As illustrated in FIG. 4, the fluid passages 138d, 138e, and 138f are aligned with the fluid chambers 308, 310, and 312, respectively. In this case, pressurized fluid can cause the fluid chambers 308, 310, and 312 to expand, and thus cause the rotor 148 to rotate in the counterclockwise direction.

In a similar manner, when the components of the hydraulic motor 100 are in the positions illustrated in FIG. 4, lower pressure fluid drains from the fluid chambers 302, 304, 306, and 314 and is directed by the commutator 120 from the fluid passages 138a, 138b, 138c, and 138g to the chamber 136. This allows the fluid chambers 302, 304, 306, and 314 to contract.

Referring back to FIGS. 1-2, as the rotor 148 rotates, the drive link 144 rotates therewith due to engagement of the splines 159, 160. In turn, rotation of the drive link 144 can cause the output shaft 177 of the hydraulic motor 100 to rotate due to engagement of the splines 175, 176. The output shaft 177 can be coupled to a wheel of a machine (e.g., a lawn mower), and can thus rotate the wheel to propel the machine.

As mentioned above, the passages 151 in the stator 146 have multiple purposes purpose. They accommodate the bolts 118 for torque resistance, allow fluid flow around the bolts 118 to or from the first port 200, and operate as a pressure vessel for pressurized fluid. As the rotor 148 rotates within the stator 146 and the external lobes 162 of the rotor 148 engage the rollers 154, a torque is applied to the stator 146. The bolts 118 carry at least a portion of such torque.

In other words, torque is transferred from the stator 146 to the bolts 118. As such, it may be desirable to increase the number of bolts 118 such that the torque is distributed among a larger number of bolts. By having the passages 151 operate as both fluid flow conduits and holes for the bolts 118, a larger number of bolts 118 can be used compared to a configuration where separate holes are used for the bolts 118 and other passages are used for the fluid flow in a given space.

Further, the bolts 118 clamp the components of the hydraulic motor 100 axially. Particularly, the bolts 118 retain the end plate 102, the commutator ring 122, the manifold 104, the rotor set assembly 106 (particularly the stator 146), and the wear plate 108 to the housing 110. As such, the bolts 118 are also subjected to axial loads to clamp these components together and preventing the hydraulic motor 100 from disassembling during operation.

As such, the configuration or shape of the passages 151 may affect the performance of the hydraulic motor 100. It may be desirable to configure the passages 151 such that the cross-sectional area around the bolts 118 is large to accommodate a larger fluid flow rate while reducing the pressure drop (pressure decrease) as fluid flows through the passages 151. It may also be desirable to configure the passages 151 in a manner that reduces the manufacturing cost of the hydraulic motor 100.

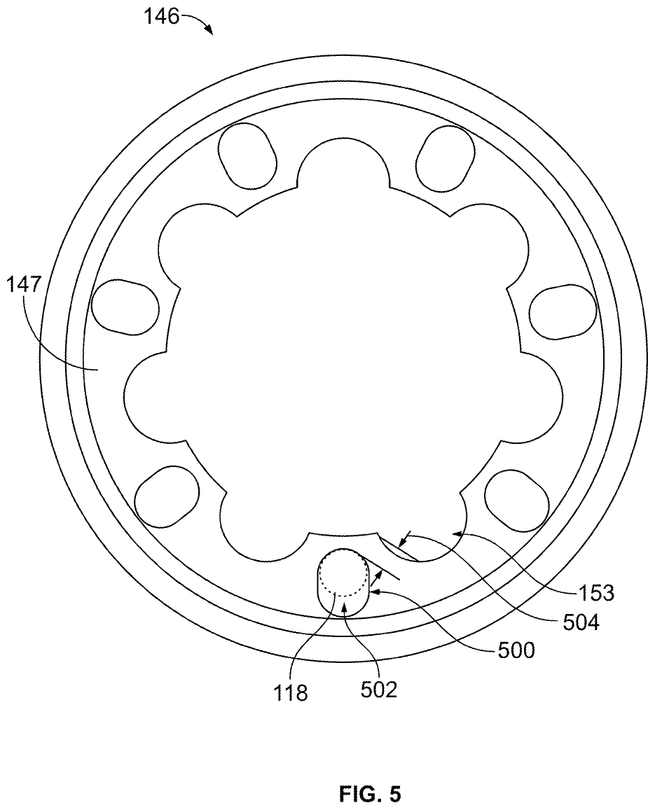

FIG. 5 illustrates a cross-sectional view of the stator 146 including passages such as passage 500 having a substantially oval shape, in accordance with an example implementation. The rollers 154 are not shown to reduce visual clutter in the drawing. The passages 500 represent the passages 151 described above, for example. The passages 500 are formed in a circular array about the stator body 147 as shown.

The passages can be referred to in the singular as the passage 500 to refer to a particular passages or in the plural as passages 500 to collectively refer to the passages of the stator 146. The passages 500 extend through the stator 146 and accommodate the bolts 118 therethrough. Only one passage is labelled and the bolt 118 is shown disposed therethrough in dashed line for illustration.

The “shape” of the passage 500 is used herein to refer to a cross-sectional profile of the passage 500. As depicted in FIG. 5, the passage 500 has straight sides and circular radial ends to give it the substantially oval shape. As shown, the bolt 118 is shifted radially inward toward the radially-inward end of the passage 500 (i.e., toward the center of the stator 146). A flow area 502 formed around the bolt 118 (e.g., radially outward from the bolt 118) allows fluid flow through the passage 500.

As shown in FIG. 5, a thickness 504 separates the passage 500 from the edge or boundary of the roller pocket 153 that accommodate the rollers 154. The thickness 504 is associated with the strength of the stator 146, i.e., the ability of the stator 146 to withstand forces and torques.

To machine the passage 500 during manufacturing of the stator 146, a two-step process may be implemented. In the first step a drill can be used to make a circular hole through the stator 146. Then a broaching bar can be used to generate the oval shape of the passage 500.

In some examples, it might be difficult to maintain the shape and dimensions of the passages 500 over time as the broaching bars wear. Further, broaching machinery are expensive. Further, the broaching step limits the ability to configure the passages 500 to have a different shape that enhances fluid flow while reducing manufacturing cost. It may thus be desirable to configure the passages of the stator 146 to have a different profile or shape that enhances the fluid flow area, while being less costly to machine, and while maintaining the thickness 504.

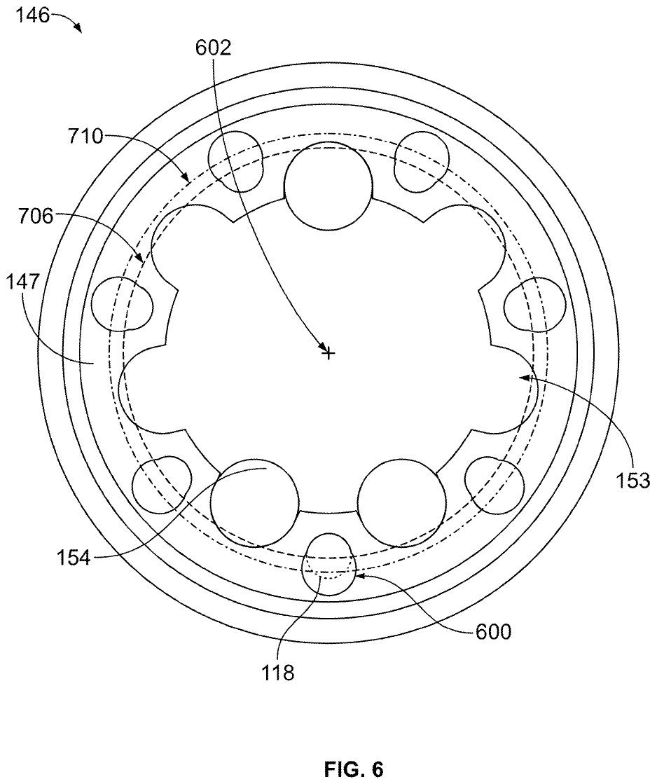

FIG. 6 illustrates a cross-sectional view of the stator 146 including passages 600 having a composite profile of two holes, in accordance with an example implementation. The rollers 154 are shown in some of the roller pockets 153 but not all the roller pockets to reduce visual clutter in the drawing. The passages 600 represent the passages 151 described above, for example, and are formed in a circular array about the stator body 147 as shown.

The passages 600 extend axially through the stator body 147 and accommodate the bolts 118 therethrough. Only one passage 600 is labelled and the bolt 118 is shown disposed therethrough in dashed line for illustration.

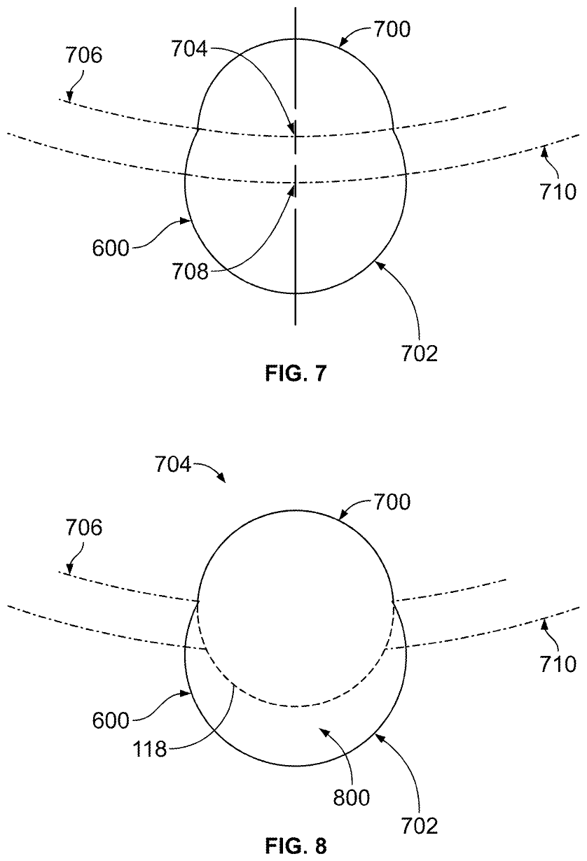

FIG. 7 illustrates a partial, enlarged cross-sectional view of the stator 146 shown in FIG. 6, in accordance with an example implementation. Particularly, FIG. 7 provides a zoomed-in view that enlarges one of the passages 600 to depict its details.

As shown in FIG. 7, the passage 600 has a shape that is a composite of two circular holes, a first hole 700 and a second hole 702 that intersect to form a profile of the passage 600. The first hole 700 is smaller than the second hole 702 (i.e., a diameter of the first hole 700 is smaller than a respective diameter of the second hole 702).

A center 704 of the first hole 700 (and all centers of the respective first holes of the passages 600) is disposed on a first circle 706, while a center 708 of the second hole 702 (and all respective centers of the respective second holes of the passages 600) is disposed on a second circle 710. The second circle 710 has a larger diameter than the first circle 706. Particularly, referring to FIGS. 6-7 together, a radius of the second circle 710 (e.g., distance from a center 602 of the stator 146 to the second circle 710) is larger than a respective radius of the first circle 706 (i.e., distance from the center 602 of the stator 146 to the first circle 706). As such, the center 708 of the second hole 702 is shifted radially-outward from the center 704 of the first hole 700.

As examples for illustration, a diameter of the first hole 700 may be about 0.396 inches, while a diameter of the second hole 702 may be about 0.46 inches. As such, a ratio of the dimeter of the first hole 700 to the diameter of the second hole 702 can be about 1.16. A diameter of the first circle 706 may be about 3.5 inches, while a diameter of the second circle 710 may be about 3.696 inches. These numbers are examples for illustration only, and other dimensions and ratios could be implemented. For example, bigger motors may have larger holes and circles.

FIG. 8 illustrates the partial, enlarged cross-sectional view of FIG. 7 with the bolt 118 disposed in the passage 600, in accordance with an example implementation. In FIG. 8, the bolt 118 is depicted in a dashed line. In the example implementation of FIG. 8, the bolt 118 is shifted radially inward toward the first hole 700. For instance, the center of the bolt 118 may generally coincide with the center 704 of the first hole 700 shown in FIG. 8. The term “generally coincide” is used herein to indicate that a center of the bolt 118 coincides with or is within a threshold distance (e.g., 1-2 millimeters) from a center of the first hole 700.

A flow area 800 is formed around the bolt 118 (e.g., radially outward from the bolt 118) in the second hole 702 to allow fluid flow through the passage 600. In an example, while a cross-sectional area of the flow area 502 of the implementation in FIG. 5 can be about 0.19 square inches, a respective cross-sectional area of the flow area 800 can be about 0.192 square inches, while maintaining the thickness 504.

Thus, a larger flow area can be provided by the implementation of FIGS. 6-8 compared to the implementation of FIG. 5, while the thickness that is similar to the thickness 504 can be maintained the same. Thus, a larger flow area can be obtained without affecting strength of the stator 146.

Further, machining the passage 600 can be less costly compared to the passage 500. Particularly, the passage 600 can be done in two drilling steps, without the need for a broaching step. For example, a drill can be centered at the center 704 of the first hole 700 and a first drill bit is used to drill the first hole 700. Then, the drill is shifted radially outward to be centered around the center 708, and a second, larger drill bit is used to drill the second hole 702. This process may simplify, and reduce the cost of, machining the passages (e.g., the passages 151, 600) of the stator 146 that accommodate the bolts 118 while allowing fluid flow therethrough.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiment (EEEs) listed below.

EEE 1 is a stator of a hydraulic motor, the stator comprising: a stator body having (i) a central opening configured to receive a rotor therein, and (ii) a plurality of vanes configured to interact with lobes of the rotor; and a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter.

EEE 2 is the stator of EEE 1, wherein the first hole and the second hole intersect to form the passage.

EEE 3 is the stator of EEE 2, wherein a center of the second hole is shifted radially-outward from a respective center of the first hole relative to a center of the stator body.

EEE 4 is the stator of EEE 3, wherein the respective bolt is configured to be disposed in the passage such that a center of the respective bolt generally coincides with the respective center of the first hole.

EEE 5 is the stator of EEE 4, wherein the passage comprises a flow area around the respective bolt in the second hole to allow fluid flow therethrough.

EEE 6 is a hydraulic motor comprising: a stator comprising (i) a stator body having a central opening, (ii) a plurality of vanes, and (iii) and a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter; and a rotor disposed within the central opening of the stator body, wherein the rotor comprises a plurality of external lobes configured to engage with the plurality of vanes of the stator, such that the plurality of vanes and the plurality of external lobes define fluid chambers therebetween configured to expand and contract as the rotor rotates within the stator.

EEE 7 is the hydraulic motor of EEE 6, wherein the first hole and the second hole intersect to form the passage.

EEE 8 is the hydraulic motor of EEE 7, wherein a center of the second hole is shifted radially-outward from a respective center of the first hole relative to a center of the stator body.

EEE 9 is the hydraulic motor of EEE 8, wherein the respective bolt is configured to be disposed in the passage such that a center of the respective bolt generally coincides with the respective center of the first hole.

EEE 10 is the hydraulic motor of EEE 9, wherein the passage comprises a flow area around the respective bolt in the second hole to allow fluid flow therethrough.

EEE 11 is the hydraulic motor of any of EEEs 6-10, wherein centers of respective first holes of the plurality of passages are disposed on a first circle, and wherein centers of respective second holes of the plurality of passages are disposed on a second circle that is shifted radially-outward from the first circle relative to a center of the stator body.

EEE 12 is the hydraulic motor of any of EEEs 6-11, further comprising:

a manifold interfacing with the stator and the rotor, wherein the manifold comprises a plurality of fluid passages configured to communicate fluid received through the plurality of passages of the stator to the fluid chambers.

EEE 13 is the hydraulic motor of EEE 12, further comprising: a housing, wherein the housing receives the respective bolts therein to clamp the stator, the rotor, and the manifold to the housing; and a first port and a second port, wherein fluid received at the first port is communicated through the plurality of passages of the stator, then through the manifold to the fluid chambers, and wherein fluid discharged from the fluid chambers is communicated through the manifold to the second port.

EEE 14 is a hydraulic transmission comprising: a pump configured to provide fluid; and a hydraulic motor fluidly coupled to the pump and configured to receive fluid therefrom, wherein the hydraulic motor comprises: a stator comprising (i) a stator body having a central opening, (ii) a plurality of vanes, and (iii) and a plurality of passages disposed in a circular array in the stator body and extending axially through the stator body, wherein the plurality of passages are configured to receive respective bolts therethrough while allowing fluid flow from the pump through each passage around a respective bolt disposed in the passage, wherein the passage comprises a composite of a first hole and a second hole, wherein the first hole has a first diameter and the second hole has a second diameter larger than the first diameter, and a rotor disposed within the central opening of the stator body, wherein the rotor comprises a plurality of external lobes configured to engage with the plurality of vanes of the stator, such that the plurality of vanes and the plurality of external lobes define fluid chambers therebetween configured to expand and contract as the rotor rotates within the stator.

EEE 15 is the hydraulic transmission of EEE 14, wherein the first hole and the second hole intersect to form the passage, wherein a center of the second hole is shifted radially-outward from a respective center of the first hole relative to a center of the stator body.

EEE 16 is the hydraulic transmission of EEE 15, wherein the respective bolt is configured to be disposed in the passage such that a center of the respective bolt generally coincides with the respective center of the first hole.

EEE 17 is the hydraulic transmission of EEE 16, wherein the passage comprises a flow area around the respective bolt in the second hole to allow fluid flow therethrough.

EEE 18 is the hydraulic transmission of any of EEEs 14-17, wherein centers of respective first holes of the plurality of passages are disposed on a first circle, and wherein centers of respective second holes of the plurality of passages are disposed on a second circle that is shifted radially-outward from the first circle relative to a center of the stator body.

EEE 19 is the hydraulic transmission of any of EEEs 14-18, further comprising: a manifold interfacing with the stator and the rotor, wherein the manifold comprises a plurality of fluid passages configured to communicate fluid received through the plurality of passages of the stator to the fluid chambers.

EEE 20 is the hydraulic transmission of EEE 19, wherein the hydraulic motor further comprises: a housing, wherein the housing receives the respective bolts therein to clamp the stator, the rotor, and the manifold to the housing; and a first port and a second port, wherein fluid received at the first port is communicated through the plurality of passages of the stator, then through the manifold to the fluid chambers, and wherein fluid discharged from the fluid chambers is communicated through the manifold to the second port.

What is claimed is:

1. A stator of a hydraulic motor, the stator comprising:
a stator body having (i) a central opening configured to receive a rotor therein, and (ii) a plurality vanes configured to interact with lobes of the rotor; and
a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter.

2. The stator of claim 1, wherein the first hole and the second hole intersect to form the passage.

3. The stator of claim 2, wherein a center of the second hole is shifted radially-outward from a respective center of the first hole relative to a center of the stator body.

4. The stator of claim 3, wherein the respective bolt is configured to be disposed in the passage such that a center of the respective bolt generally coincides with the respective center of the first hole.

5. The stator of claim 4, wherein the passage comprises a flow area around the respective bolt in the second hole to allow fluid flow therethrough.

6. A hydraulic motor comprising:
a stator comprising (i) a stator body having a central opening, (ii) a plurality of vanes, and (iii) and a plurality of passages disposed in a circular array in the stator body and extending axially through the stator body, wherein the plurality of passages are configured to receive respective bolts therethrough while allowing fluid flow through each passage around a respective bolt disposed in the passage, wherein the passage comprises a composite of a first hole and a second hole, wherein the first hole has a first diameter and the second hole has a second diameter larger than the first diameter; and
a rotor disposed within the central opening of the stator body, wherein the rotor comprises a plurality of external lobes configured to engage with the plurality of vanes of the stator, such that the plurality of vanes and the plurality of external lobes define fluid chambers therebetween configured to expand and contract as the rotor rotates within the stator.

7. The hydraulic motor of claim 6, wherein the first hole and the second hole intersect to form the passage.

8. The hydraulic motor of claim 7, wherein a center of the second hole is shifted radially-outward from a respective center of the first hole relative to a center of the stator body.

9. The hydraulic motor of claim 8, wherein the respective bolt is configured to be disposed in the passage such that a center of the respective bolt generally coincides with the respective center of the first hole.

10. The hydraulic motor of claim 9, wherein the passage comprises a flow area around the respective bolt in the second hole to allow fluid flow therethrough.

11. The hydraulic motor of claim 6, wherein centers of respective first holes of the plurality of passages are disposed on a first circle, and wherein centers of respective second holes of the plurality of passages are disposed on a second circle that is shifted radially-outward from the first circle relative to a center of the stator body.

12. The hydraulic motor of claim 6, further comprising:
a manifold interfacing with the stator and the rotor, wherein the manifold comprises a plurality of fluid passages configured to communicate fluid received through the plurality of passages of the stator to the fluid chambers.

13. The hydraulic motor of claim 12, further comprising:
a housing, wherein the housing receives the respective bolts therein to clamp the stator, the rotor, and the manifold to the housing; and
a first port and a second port, wherein fluid received at the first port is communicated through the plurality of passages of the stator, then through the manifold to the fluid chambers, and wherein fluid discharged from the fluid chambers is communicated through the manifold to the second port.

14. A hydraulic transmission comprising:
a pump configured to provide fluid; and
a hydraulic motor fluidly coupled to the pump and configured to receive fluid therefrom, wherein the hydraulic motor comprises:
a stator comprising (i) a stator body having a central opening, (ii) a plurality of vanes, and (iii) and a plurality of passages disposed in a circular array in the stator body and extending axially through the stator body, wherein the plurality of passages are configured to receive respective bolts therethrough while allowing fluid flow from the pump through each passage around a respective bolt disposed in the passage, wherein the passage comprises a composite of a first hole and a second hole, wherein the first hole has a first diameter and the second hole has a second diameter larger than the first diameter, and
a rotor disposed within the central opening of the stator body, wherein the rotor comprises a plurality of external lobes configured to engage with the plurality of vanes of the stator, such that the plurality of vanes and the plurality of external lobes define fluid chambers therebetween configured to expand and contract as the rotor rotates within the stator.

15. The hydraulic transmission of claim 14, wherein the first hole and the second hole intersect to form the passage, wherein a center of the second hole is shifted radially-outward from a respective center of the first hole relative to a center of the stator body.

16. The hydraulic transmission of claim 15, wherein the respective bolt is configured to be disposed in the passage such that a center of the respective bolt generally coincides with the respective center of the first hole.

17. The hydraulic transmission of claim 16, wherein the passage comprises a flow area around the respective bolt in the second hole to allow fluid flow therethrough.

18. The hydraulic transmission of claim 14, wherein centers of respective first holes of the plurality of passages are disposed on a first circle, and wherein centers of respective second holes of the plurality of passages are disposed on a second circle that is shifted radially-outward from the first circle relative to a center of the stator body.

19. The hydraulic transmission of claim 14, further comprising:
a manifold interfacing with the stator and the rotor, wherein the manifold comprises a plurality of fluid passages configured to communicate fluid received through the plurality of passages of the stator to the fluid chambers.

20. The hydraulic transmission of claim 19, wherein the hydraulic motor further comprises:
a housing, wherein the housing receives the respective bolts therein to clamp the stator, the rotor, and the manifold to the housing; and
a first port and a second port, wherein fluid received at the first port is communicated through the plurality of passages of the stator, then through the manifold to the fluid chambers, and wherein fluid discharged from the fluid chambers is communicated through the manifold to the second port.
